(19) United States
(12) Patent Application Publication
(10) Pub. No.: US 2025/0228733 A1
(43) Pub. Date: Jul. 17, 2025

(54) METHODS AND PRODUCTS FOR ENHANCING BLOOD FLOW TO AN ANATOMICAL REGION

(71) Applicant: Growth Armor, LLC, Wilmington, DE (US)

(72) Inventor: Michael A. Bain, Costa Mesa, CA (US)

(21) Appl. No.: 18/412,889

(22) Filed: Jan. 15, 2024

(51) Int. Cl. A61H 19/00

(52) U.S. Cl. CPC A61H 19/34; A61H 2201/0107; A61H 2201/0119; A61H 2201/0153; A61H 2201/0157; A61H 2201/1602; A61H 2201/1647; A61H 2201/169; A61H 2205/087

(57) ABSTRACT

Methods and systems are disclosed for enhancing blood flow to anatomical regions. An applicator may include a stimulation portion operative to define a protrusion extending from the applicator. Positioning the applicator in relation to the anatomical region may emplace the protrusion upon a predetermined area thereof, resulting in stimulation being applied thereto. A blood flow enhancement device can be used alongside the applicator to apply suction, heating, and/or vibration effects to the anatomical region, via the blood flow enhancement device having a vacuum, an ultrasonic transducer and/or a vibrator. An inner surface of the applicator's protrusion may receive a portion of the blood flow enhancement device, allowing a user to impart these effects upon the predetermined area the protrusion is associated with. The combination of stimulating, heating, vibrating, and/or suctioning the anatomical region in this manner can allow treatments like therapies, diagnostics, and pleasure to be administered to a user.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Field of Invention

The present application relates to treatments for enhancing blood flow to anatomical regions of a patient. More specifically, the present application relates to applying stimulation, vibration, heating, and/or suction effects to an anatomical region of a patient with a applicator and a blood flow enhancement device for treatments like therapies, diagnoses, and/or pleasure.

### 2. Related Art

Vascular disorders may result in reduced blood flow to one's anatomical regions, causing the organs associated therewith to malfunction due to inadequate water/nutrient supply. The dysfunctionality of sexual organs is a common example of such a phenomenon, as abnormal vascular circulation can result in pain, discomfort, impotence, delayed vaginal engorgement, etc. These disorders can stem from old age, high blood pressure, plaque buildup in arteries, smoking, bodily trauma, and more.

Numerous vasodilation therapies have emerged to identify and treat these issues, primarily through the development of medicines. Typically, by binding with endothelial cells of blood vessels and stimulating calcium release, these medicines can increase blood flow by allowing for vascular muscle relaxation. However, many of these medicines can have adverse side effects on a consumer ranging from palpitations, edema, nausea, headaches, chest pain, and fatigue. Instruments which can diagnose and/or administer therapeutic treatments for these vascular disorders have yet to see widespread usage or to be proven as effective alternatives. Thus, it can be seen that new and improved methodologies and products which can stimulate blood flow to particular anatomical regions of a patient to treat vascular disorders are desired in the art.

### BRIEF SUMMARY

To solve these and other problems, methods and systems are disclosed whereby blood flow to a patient's anatomical regions can be enhanced. An applicator and a blood flow enhancement device may be used upon an anatomical region to stimulate, heat, vibrate, and/or apply suction thereto. In particular, the applicator may be operative to form a protrusion extending therefrom; with a proper positioning of the applicator, this protrusion may be emplaced upon the anatomical region to impart stimulation thereto. Depending on the precise positioning of the applicator and the configuration of the protrusion, a specific, predetermined area of an anatomical region can be targeted. The blood flow enhancement device can be received by and nestled within the inner surface of the protrusion on the top surface of the applicator, allowing a vacuum, and/or ultrasonic transducer of the device to target this same predetermined area the protrusion is associated with. It can be seen that targeted treatments like therapeutics, diagnostics, and pleasure can be provided with the use of these implements.

A method for enhancing blood flow to an anatomical region of a patient may comprise the steps of positioning an applicator in relation to the anatomical region and actuating a vacuum of a blood flow enhancement device to apply suction to that anatomical region. The applicator may comprise at least a stimulation portion, which can be operative to define a protrusion with an outer surface and an inner surface, and a membrane portion comprising an impermeable material. The blood flow enhancement device can comprise a distal end, proximal end, and a tube defining a fluid passageway within the device, with this passageway fluidly connecting a vacuum and an opening defined by the distal end to facilitate the application of suction.

Amongst other anatomical regions, the glans (male or female), the clitoris, and the anterior wall of a vagina can be treated in this manner. The size of the applicator's protrusion may be adjusted during a treatment procedure. The positioning of the applicator can emplace the stimulation portion's protrusion at a predetermined area of the anatomical region such that the protrusion is operative to stimulate that predetermined area. Through another step of positioning the blood flow enhancement device, a portion thereof can be nestled in the inner surface of the protrusion, allowing suction to be applied to the same predetermined area. The stimulation portion could comprise a receiving structure which may receive and be coupled with a portion of the distal end of the blood flow enhancement device to ensure a proper positioning thereof. This coupling of the portion of the distal end with the receiving structure may form a hermetic seal to help create a stronger suction effect.

The blood flow enhancement device could further comprise a vibrator, in which case a further step of actuating the vibrator to apply vibration to the anatomical region may be carried out. An ultrasonic transducer can also be included in the blood flow enhancement device, which can be actuated to apply heat to the anatomical region. The blood flow enhancement device can be positioned such that ultrasonic waves emitted by this ultrasonic transducer could transmitted through the stimulation region of the applicator, which may be aided via the stimulation region being made of materials with low attenuation coefficients.

A product which can carry out these treatments may comprise at least one applicator and a blood flow enhancement device. Each of the applicators can comprise at least a stimulation portion, the stimulation portion being operative to define a protrusion extending from the applicator, the protrusion defining an outer surface and an inner surface, and a membrane portion, the membrane portion comprising an impermeable material. The blood flow enhancement device could have a distal end, a proximal end, and a tube defining a fluid passageway within the device, with this passageway fluidly connecting a vacuum and an opening defined by the distal end.

The stimulation portion of the applicators can comprise a receiving structure which can be coupled with the distal end of the blood flow enhancement device. Said coupling of the portion of the distal end with the receiving structure can form a hermetic seal. Protrusions of the applicators may be operative to be adjusted. Applicators may be shaped in relation to the target anatomical region, such as a male glans, a female glans, a labia majora, a labia minora, a clitoris, or an anterior wall of a vagina.

The vacuum of the blood flow enhancement device can be adjusted to change the level of suction applied. The blood flow enhancement device may further comprise a vibrator for imparting vibrations to the anatomical region. An ultrasonic transducer can be included in the blood flow enhancement device; in such cases, the stimulation portion of the applicators can be operative to permit ultrasonic waves to be transmitted therethrough via being made of materials with low attenuation coefficients.

All of these embodiments are contemplated to be within the scope of this disclosure. These and other embodiments will become readily apparent to those skilled in the art form the following detailed description of the preferred embodiments having reference to the attached figures, the disclosure not being limited to any particular preferred embodiment.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a top view of an exemplary embodiment of an applicator;

FIG. 2 is a cross-sectional slice side view along line 2-2 of the applicator depicted in FIG. 1;

FIG. 3 is the top view of the exemplary embodiment of the applicator depicted in FIG. 1 with the further inclusion of a receiving structure;

FIG. 4 is a cross-sectional slice side view of the applicator depicted in FIG. 3 along line 4-4 as well a blood flow enhancement device; and

FIG. 5 is an example of a treatment procedure using an applicator and a blood flow enhancement device.

Common reference numerals are used throughout the drawings and the detailed description to indicate the same elements.

### DETAILED DESCRIPTION

The following description encompasses various embodiments of methods and systems which can increase blood flow to an anatomical region of a patient. An applicator having at least a stimulation portion and a membrane portion may be positioned in relation to the anatomical region. The stimulation portion may be configured so that it can define an adjustable protrusion extending from the applicator, which may serve to stimulate the anatomical region or a particular, predetermined area thereof; the degree of stimulation and the area stimulated may depend on the size of the protrusion and the positioning of the applicator. A blood flow enhancement device can be used alongside the applicator to impart heating, vibration, and/or suction effects to the anatomical region. The configuration of the applicator may allow it to receive the blood flow enhancement device, such as via an inner surface of the protrusion being operative to receive the device, permitting these effects to be imparted at the same area of the anatomical region the protrusion is associated with. The combination of stimulating, heating, vibrating, and/or suctioning of the anatomical region or a predetermined area thereof in this manner may allow for treatments such as vasodilation therapies, diagnostics, or pleasure to be effectively and efficiently administered to a patient at precise sectors of that patient's body.

Heating effects may be provided via the blood flow enhancement device incorporating an ultrasonic transducer capable of high-intensity focused ultrasound (HIFU) techniques. The stimulation portion of the applicator may permit these ultrasonic waves to pass through with low attenuation by virtue of the stimulation portion being made of materials with low attenuation coefficients. Similarly, a vibrator and/or a vacuum can be included in the device to provide vibratory and suctional effects respectively. A distal end of the blood flow enhancement device may have a tube which can provide a fluid pathway connecting the vacuum to an opening defined by the distal end to facilitate this suction activity.

To assist in positioning the blood flow enhancement device, the stimulation portion can include a receiving structure, such as a ring-shaped structure, which can be coupled with the blood flow enhancement device (i.e., the distal end of the device could be cylindrically shaped to fit within a ring-shaped receiving structure). Depending on the configuration of the receiving structure and the device, this coupling may cause a substantially hermetic seal to be formed, which could allow suction effects to be more effectively applied to the anatomical region or a predetermined area thereof.

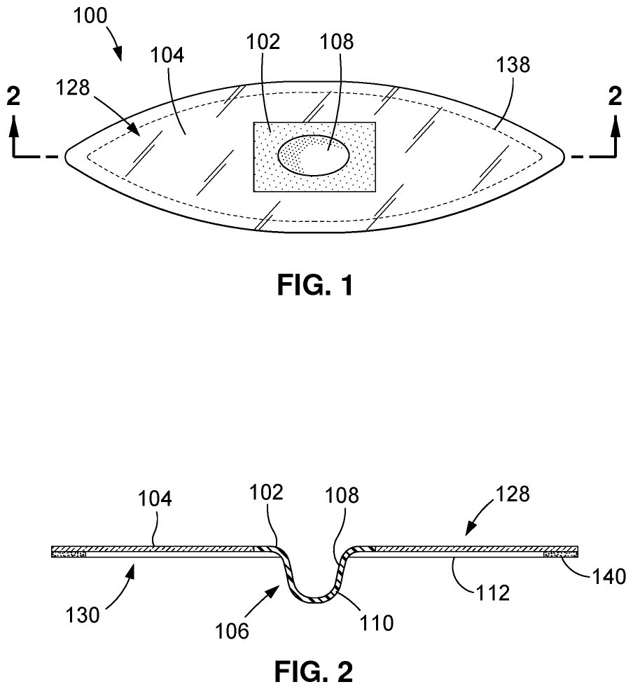

Turning first to FIGS. 1 and 2, a top view of an exemplary embodiment of an applicator and a cross-sectional slice side view thereof along line 2-2 respectively are shown. An applicator 100 may include a stimulation portion 102 and a membrane portion 104, both of which can be at least partially exposed on a top surface 128 of the applicator 100. These regions 102, 104 may be sized and configured such that at least on the top surface 128, the membrane portion 104 encompasses the stimulation portion 102 and/or the stimulation portion 102 is generally in the center of the applicator 100. The membrane portion 104 ideally comprises an impermeable material to capture bodily fluids which may otherwise scatter, which could occur in response to the administered treatment.

The stimulation portion 102 may also be at least partially exposed on an underside surface 130 of the applicator 100. Preferably, at least the exposed portion of the stimulation portion 102 corresponding to this underside surface 130 of the applicator 100 comprises a skin-friendly material (e.g., foams, medical textiles, others familiar to those skilled in the art) which would not cause irritation to the anatomical region the applicator 100 is to be positioned upon. Similarly, a contact portion 112 exposed on the underside surface 130 of an applicator 100 can comprise a skin-friendly material, either the same or different from that used in the stimulation portion 102. These portions 102, 112 could also or alternatively comprise a plastic material. To help ensure the applicator 100 stays in a proper position upon the anatomical region, an adhesive portion 140 may be at least partially exposed on the underside surface 130 of the applicator 100. This adhesive portion 140 is preferably shaped in relation to the anatomical region so as to adhere to areas thereof which would be comfortable to receive and remove adhesive from (e.g., areas of skin with lower densities and less thickness of hair). A guideline 138 may be provided on the top surface 128 of the applicator 100, corresponding to the presence of the adhesive portion 140 on the underside 130, to aid one in positioning and adhering the applicator 100. Conventional adhesives may be used in the adhesive portion 140, particularly those which would not substantially irritate the patient's skin or be painful to remove. The contact portion 112 and/or the adhesive portion 140 may be in a layer-like arrangement with the membrane portion 104 such that fluids which pass through the contact portion 112/adhesive portion 140 would not be able to pass through the membrane portion 104 and scatter as easily.

The geometry of an applicator 100, including the thickness, shape, and sizes of its portions 102, 104, 112, 140, may vary and be configured for a particular application. For instance, an applicator may be shaped in relation to an anatomical region the applicator 100 is intended to be positioned upon, such as the male glans, female glans, or clitoris of a patient. The anatomical region could also be an internal region of a patient, such as within an internal of an organ (i.e., vagina) or an anterior wall thereof. An applicator 100 would preferably be flexible, allowing one to bend and stretch the applicator 100 to a degree so that it could be used for a wide range of anatomies.

An applicator 100 may be operative to define a protrusion 106 extending therefrom. A protrusion 106 could define an inner surface 108 associated with the top surface 128 of the applicator 100 and an outer surface 110 associated with the underside surface 130 of the applicator 100 and corresponding to the side of the protrusion 106 which extends away from the applicator 100. This protrusion 106 may serve to stimulate the anatomical region via the protrusion 106 being emplaced upon the anatomical region due to the positioning of the applicator 100; the stimulation that results from this emplacement may allow blood flow to that anatomical region to be increased. By configuring the applicator 100 and the protrusion 106, and via the positioning of the applicator 100 in relation to the anatomical region, a particular, predetermined area of the anatomical region can be targeted to impart stimulation thereto, allowing one to perform targeted therapies and diagnostics on those bodily areas. If the anatomical region is an internal region of the patient, the protrusion 106 of an applicator 100 could impart stimulation to this internal region; this result could be achieved via only requiring a certain positioning of said applicator 100 upon a patient. Preferably, the protrusion 106 will maintain enough rigidity when emplaced upon the anatomical region so that it can continue to impart stimulation thereto while the applicator 100 is in its proper position.

The stimulation region 102 of a applicator 100 may be operative to define this protrusion 106. This could come in the form of the stimulation portion 102 being rigid and formed in the shape of the protrusion 106, thus naturally forming the protrusion 106. If the stimulation portion 102 comprises a plastic material, the protrusion 106 could be formed in the shape of a cone, which could impart a high degree of stimulation to a predetermined area of the anatomical region. Alternatively, the stimulation portion 102 may exhibit a degree of flexibility, allowing one to form and/or adjust the protrusion 106. For example, the stimulation portion 102 could be capable of being generally flat and planar with the applicator 100 (which could be the form in which the applicator 100 is packaged/stored), and when the applicator 100 is ready to be used, the protrusion 106 could be formed by pressing down on the stimulation portion 102 from the top surface 128, pushing the sides of an applicator 100 inwards towards the center of the applicator 100, and/or pulling a string or a similar element attached to the stimulation portion 102. The height of the protrusion 106 (which could be measured from the underside surface 130 of the applicator 100) could be adjusted using similar/the same techniques. The stimulation region 102 could be configured to have preset configurations which correspond to the protrusion 106 being set to particular sizes and/or shapes. Structures may be incorporated in the applicator 100 and/or embedded in the stimulation region 102 to aid in the adjustability and configurability of the protrusion 106. A larger protrusion may increase the stimulation applied to the anatomical region of a patient compared to a smaller one. Smaller protrusions could also be useful in case the patient/anatomical region reacts adversely to larger protrusions.

The stimulation portion 102 preferably would be operative to define a protrusion 106 extending from the underside surface 130 of the applicator 100, although the stimulation portion 102 could also or alternatively be operative to define a protrusion extending from the top surface 128 of the applicator 100 such that inner surface 108 of the protrusion is associated with the underside surface 130 of the applicator 100 and the outer surface of the protrusion 106 is associated with the top surface 128 of the applicator 100. Depending on the configuration of the applicator 100 and/or the stimulation region 102, more than one protrusion 106 could be formed from a stimulation portion 102 and be spaced apart from each other therein. A applicator 100 could also or alternatively have multiple simulation portions 102 each of which can define protrusions 106 which correspond to different areas of an anatomical region. A protrusion 106 preferably has a smooth, fingerlike-projection shape, although it could also or alternatively form different shapes and have sharper edges.

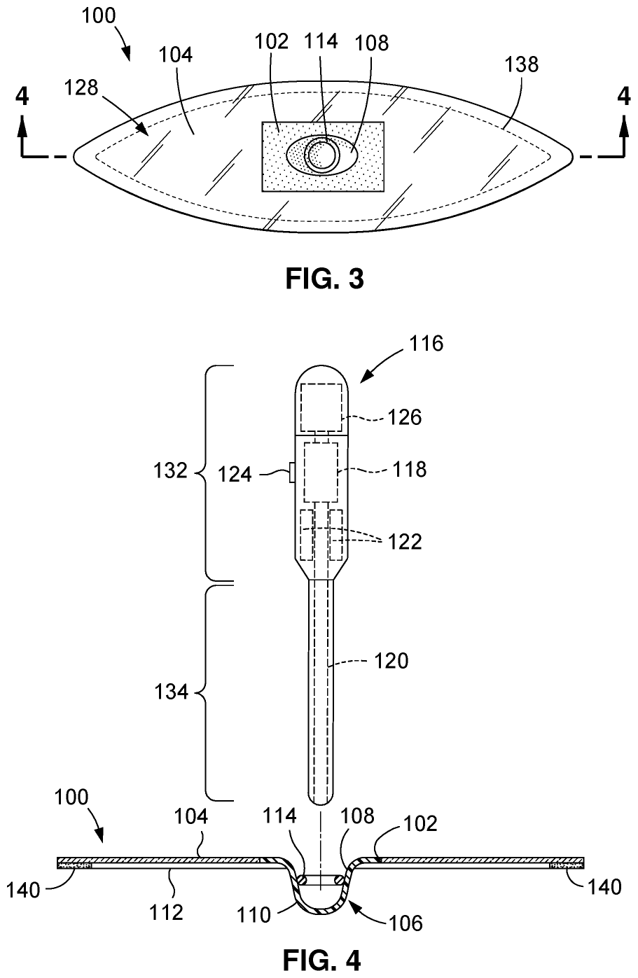

Looking now to FIG. 3, the top view of the exemplary applicator of FIG. 1 is shown with the inclusion of a receiving structure. A receiving structure 114 could be built into a applicator 100 or be a separate component that can be positioned in and removed from the applicator 100. As such, a receiving structure 114 could be embedded within the stimulation portion 102 or be operative to be coupled with the stimulation portion 102 (e.g., the receiving structure 114 fits within a recess defined by the stimulation portion 102). This receiving structure 114 may be operative to receive and be coupled with a blood flow enhancement device 116, as will be discussed later in this disclosure.

Looking also at FIG. 4, a cross-sectional slice side view of the applicator of FIG. 3 along line 4-4 as well as a blood flow enhancement device is shown. A blood flow enhancement device 116, which could have a proximal end 132 and a distal end 134, can be used to impart effects onto the anatomical region, such as heating, vibration, and/or suction, to enhance blood flow to that anatomical region further. During a treatment procedure, the blood flow enhancement device 116 can be positioned relative to the applicator 100 such that when one or more of the functionalities of the blood flow enhancement device 116 are actuated, one or more effects are imparted upon the anatomical region. If the stimulation portion 102 defines a protrusion 106, this positioning may entail nestling a portion of the blood flow enhancement device 116 in the inner surface 108 defined by the protrusion 106, which could be accomplished by coupling the blood flow enhancement device 116 with the receiving structure 114 (i.e., a distal end 134 of the device 116 fitting within the receiving structure 114 embedded in the stimulation portion 102). In such a configuration, the effects imparted by the blood flow enhancement device 116 could be targeted upon the predetermined area of the anatomical region the protrusion 106 is associated with. The device 116 could still be movable relative to the receiving structure 114 when coupled thereto (e.g., axial movement thereof), which may be done during a treatment procedure to modify the effects imparted by the device 116.

A heating effect can be imparted via the blood flow enhancement device 116 having an ultrasonic transducer which can transmit ultrasonic waves through the applicator 100. Preferably, the waves can be transmitted through the stimulation region 102, which can be aided via the stimulation region 102 being made of materials with low attenuation coefficients, thus permitting the ultrasonic waves to pass therethrough. High-intensity focused ultrasound (HIFU) can be administered through such a methodology to heat the anatomical region; the ultrasonic transducer frequency may be adjustable to allow a user to change degree of heating imparted.

A blood flow enhancement device 116 could have a vibrator 122 to apply vibration to the anatomical region. When a portion of the blood flow enhancement device 116 is nestled in the inner surface 108 of the protrusion 106, activating the vibrator 122 may apply vibrations to the anatomical region, although holding the blood flow enhancement device 116 upon other sections of an applicator 100 may allow similar vibrations to be applied to the anatomical region.

For applying suction effects to the anatomical region, the blood flow enhancement device 116 could include a tube 120 defining a fluid pathway between an opening defined by the distal end 134 of the device 116 and a vacuum 118, which could be present in the proximal end 132 of the device 116. Suction may be applied through the applicator 100, preferably through the stimulation portion 102, to increase blood flow to the anatomical region further. Positioning a portion of the blood flow enhancement device 116 such that it is nestled in the inner surface 108 of the protrusion 106 could allow suction to be applied to the predetermined area of the anatomical region the protrusion 106 is associated with. The coupling of the blood flow enhancement device 116 with the receiving structure 114 may cause a hermetic seal to be formed within the inner surface 108 of a protrusion, allowing a stronger suctional effect to be applied upon the predetermined area of the anatomical region. It can be seen that any combination of stimulation, heating, vibration, and suction effects can be administered upon an anatomical region, thus providing a myriad of ways to administer a treatments like therapies, diagnostics, and pleasure via inducing blood flow changes thereto.

A blood flow enhancement device 116 and its components could be powered by a battery 126 that fits within the proximal end 132 of the blood flow enhancement device 116, allowing the device 116 to be comfortably held and positioned with the hands and for the battery 126 to be replaced as needed. Other devices could be plugged into a wall outlet or be part of a larger machine. In this respect, the blood flow enhancement device 116 could be, for instance, packaged and sold as a product alongside a stack of applicators 100 or a subcomponent of a medical device in a hospital with the applicators 100 being acquired separately. Blood flow enhancement devices 116 or the machines they are associated with could include one or more actuators 124 to turn on the device 116 and/or activate individual components thereof (vibrator 122, vacuum 118).

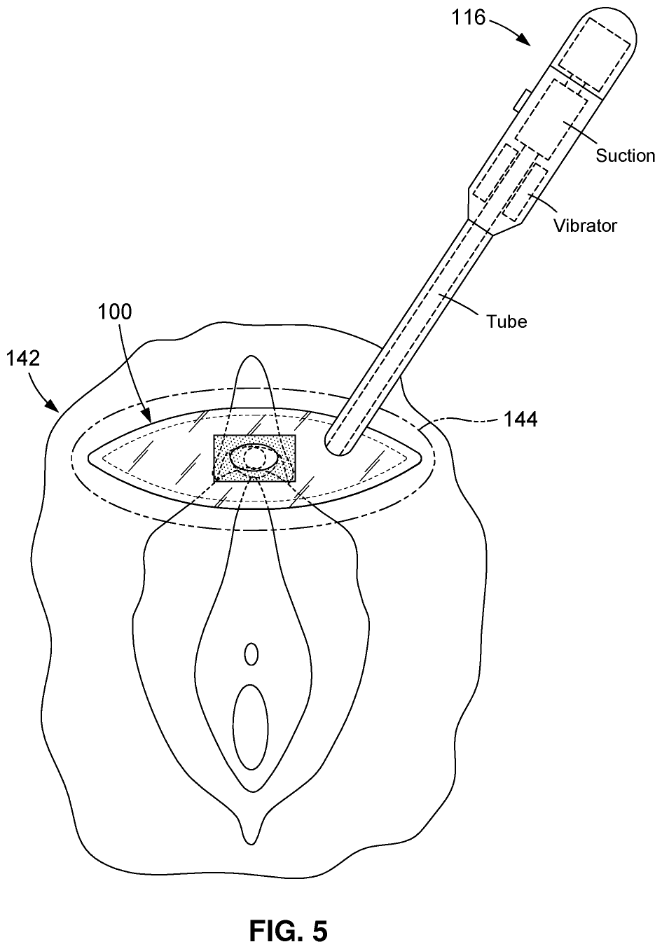

Looking now to FIG. 5, an example of a treatment procedure using an applicator and a blood flow enhancement device is shown. Here, it can be seen that by positioning an applicator 100 upon a subregion 144 of an anatomical region 142, the protrusion 106 can be emplaced against a predetermined area thereof. By positioning the blood flow enhancement device 116 (via nestling it within the inner surface 108 of the protrusion 106), heat, vibration, and/or suction effects can be applied to this predetermined area in addition to the stimulation effect imparted by the protrusion 106. This type of treatment procedure can be administered by the patient themselves or an operator/doctor. Those skilled in the art would recognize the degree and length of stimulating, heating, suction, and/or vibration effects to impart upon the anatomical region so as to administer the intended treatment. In this respect, a treatment procedure may be modified (e.g., increasing/decreasing intensity of treatment) in response to how the patient/anatomical region is reacting to the treatment (such as if the reaction is adverse or minimal). Following treatment, the applicator 100 can be removed from the anatomical region 142 and disposed of as seen fit.

The above description is given by way of example, and not limitation. Given the above disclosure, one skilled in the art could devise variations that are within the scope and spirit of this disclosure. Further, the various features of the embodiments disclosed herein can be used alone, or in varying combinations with each other and are not intended to be limited to the specific combination described herein. Thus, the scope of the claims is not to be limited by the illustrated embodiments. Additional modifications and improvements of the present disclosure may also be apparent to those of ordinary skill in the art. Thus, the particular combination of parts and steps described and illustrated herein is intended to represent only certain embodiments of the present subject matter, and is not intended to serve as limitations of alternative devices and methods within the spirit and scope of this disclosure.

What is claimed is:

1. A method for enhancing blood flow to an anatomical region of a patient, the method comprising the steps of:
positioning an applicator in relation to the anatomical region, the applicator comprising:
a stimulation portion, the stimulation portion defining a protrusion extending from the applicator, the protrusion defining an outer surface and an inner surface; and
a membrane portion, the membrane portion comprising a substantially impermeable material;
positioning a blood flow enhancement device in association with the applicator; and
actuating the blood flow enhancement device to apply a vacuum to the anatomical region, the blood flow enhancement device having a distal end and a proximal end, the blood flow enhancement device comprising a tube defining a fluid passageway therein, the fluid passageway fluidly connecting the vacuum and an opening defined by the distal end.

2. The method of claim 1, wherein said positioning of the applicator emplaces the stimulation portion at a predetermined area of the anatomical region such that the protrusion is operative to stimulate the predetermined area.

3. The method of claim 1, wherein the step of positioning the blood flow enhancement device in association with the applicator comprises locating a portion of the blood flow enhancement device in the inner surface of the protrusion.

4. The method of claim 1, wherein the stimulation portion comprises a receiving structure; and wherein the step of positioning the blood flow enhancement device in association with the applicator comprises coupling a portion of the distal end of the blood flow enhancement device with the receiving structure.

5. The method of claim 4, wherein said coupling of the portion of the distal end with the receiving structure forms a substantially hermetic seal.

6. The method of claim 1, wherein the blood flow enhancement device further comprises a vibrator; and wherein the method further comprises a step of: actuating the vibrator to apply vibration to the anatomical region.

7. The method of claim 1, wherein the blood flow enhancement device further comprises an ultrasonic transducer; and wherein the method further comprises a step of: actuating the ultrasonic transducer to apply heat to the anatomical region.

8. The method of claim 7, wherein ultrasonic waves emitted by the ultrasonic transducer are transmitted across the stimulation region.

9. The method of claim 1, wherein the method further comprises a step of: adjusting a size of the protrusion.

10. The method of claim 1, wherein the applicator is sized and configured to interface with one or more anatomical regions of a patient.

11. The method of claim 10, wherein the one or more anatomical regions are selected from the group consisting of: a male glans, a female glans, a labia majora, a labia minora, a clitoris, an anterior wall of a vagina.

12. A system for enhancing blood flow to an anatomical region of a patient, the device comprising:
at least one applicator, the least one applicator comprising:
a stimulation portion, the stimulation portion being operative to define a protrusion extending from the pad, the protrusion defining an outer surface and an inner surface; and
a membrane portion, the membrane portion comprising a substantially impermeable material; and
a blood flow enhancement device having a distal end and a proximal end, the blood flow enhancement device comprising a tube defining a fluid passageway therein, the fluid passageway being operative to impart a vacuum to the opening defined by the distal end, the blood flow enhancement device being operative to be positioned in association with the applicator so as to impart a vacuum to the anatomical region.

13. The system of claim 12, wherein the stimulation portion further comprises a receiving structure and the blood flow enhancement device further comprise a coupling portion at its distal end, and wherein the blood flow enhancement device is operative to be positioned in association with the applicator so as to impart a vacuum to the anatomical region via a coupling portion being operative to be coupled with the receiving structure.

14. The system of claim 13, wherein the coupling of the coupling portion of the distal end with the receiving structure is operative to form a substantial hermetic seal.

15. The system of claim 12, wherein the blood flow enhancement device further comprises a vibrator.

16. The system of claim 12, wherein the blood flow enhancement device further comprises an ultrasonic transducer; and wherein the stimulation portion is operative to permit ultrasonic waves to be transmitted therethrough.

17. The system of claim 12, wherein the blood flow enhancement device is operative to adjust a level of suction of the imparted vacuum.

18. The system of claim 12, wherein a size of the protrusion is operative to be adjusted.

19. The system of claim 12, wherein each of the one or more applicators is sized and configured to interface with one or more anatomical regions of a patient.

20. The system of claim 19, wherein the one or more anatomical regions are selected from the group consisting of: a male glans, a female glans, a labia majora, a labia minora, a clitoris, an anterior wall of a vagina.
